(19) United States
(12) Patent Application Publication
(10) Pub. No.: US 2015/0186010 A1
(43) Pub. Date: Jul. 2, 2015

(54) ELECTRONIC DEVICE AND METHOD THEREOF FOR ADJUSTING DESKTOP ICONS DISPLAYED THEREON

(71) Applicants: Fu Tai Hua Industry (Shenzhen) Co., Ltd., Shenzhen (CN); HON HAI PRECISION INDUSTRY CO., LTD., New Taipei (TW)

(72) Inventors: NIAN-LONG HUANG, Shenzhen (CN); CHIH-SAN CHIANG, New Taipei (TW); LING-JUAN JIANG, Shenzhen (CN); SHUANG HU, Shenzhen (CN); HUA-DONG CHENG, Shenzhen (CN)

(21) Appl. No.: 14/557,585

(22) Filed: Dec. 2, 2014

(30) Foreign Application Priority Data
Dec. 27, 2013 (CN) 201310731911.7

(51) Int. Cl. G06F 3/0481; G06F 3/0484

(52) U.S. Cl. CPC G06F 3/04817; G06F 3/04842

(57) ABSTRACT

A method for adjusting desktop icons displayed on a display of an electronic device is provided. The method includes the following steps. Recording, by a processor during every predefined time interval, a running time period of each of a plurality of applications installed on the electronic device, each of the plurality of applications being associated with an icon. Obtaining, by the processor, a quantity of use times of each of the plurality of applications. Arranging, by the processor during every predefined time interval, the icons associated the plurality of applications according to the quantity of use times and the running time periods of the plurality of applications. And controlling, by a processor during every predefined time interval, to display a desktop showing the arranged icons on the display in a predefined display manner. An electronic device using the method is also provided.

CROSS-REFERENCE TO RELATED APPLICATIONS

This application claims priority to Chinese Patent Application No. 201310731911.7 filed on Dec. 27, 2013, the contents of which are incorporated by reference herein.

### FIELD

The subject matter herein generally relates to electronic devices, and particularly to an electronic device and a method for adjusting desktop icons displayed on an electronic device.

### BACKGROUND

Electronic devices such as mobile phones, computer tablets, and personal digital assistants (PDAs), are popular and have powerful functions. The amount of icons associated with various applications running on the electronic devices have gradually increased.

### BRIEF DESCRIPTION OF THE DRAWINGS

Implementations of the present technology will now be described, by way of example only, with reference to the attached figures.

FIG. 1 is a block diagram of an electronic device in accordance with an exemplary embodiment.

FIG. 2 is a flowchart of an embodiment of a method for adjusting desktop icons displayed on an electronic device, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The word “module,” and “unit” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

The present disclosure is described in relation to an electronic device and a method for adjusting desktop icons displayed on a display of the electronic device. The method comprises the following steps: Recording a running time period of each application installed to the electronic device during a predefined time interval, each of the applications is associated with an icon. Obtaining a number of use times of each of the applications. Arranging the icons associated the applications according to the obtained quantity of use times and the recorded running time periods of the applications; and displaying a desktop showing the arranged icons on the display in a predefined display manner.

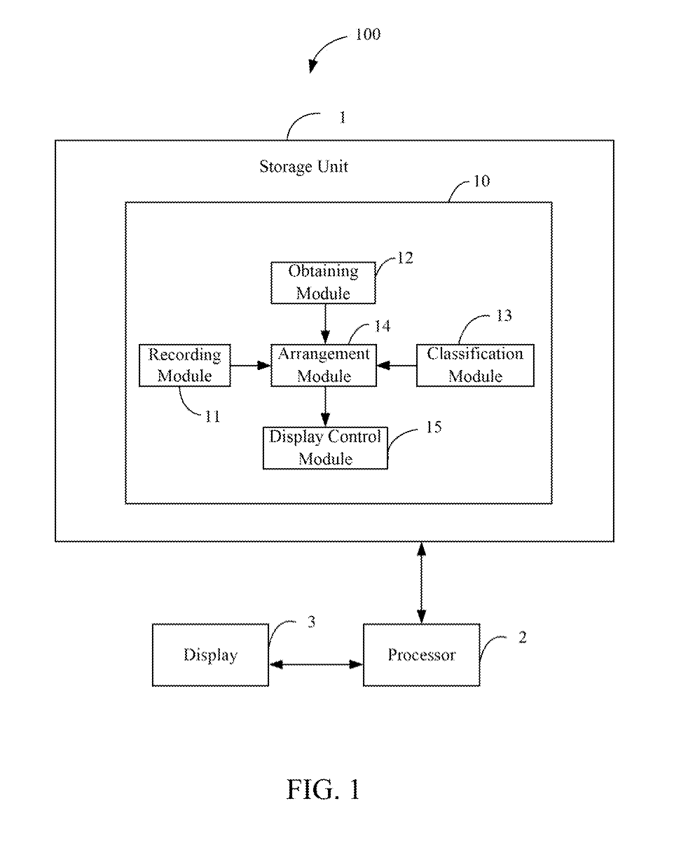

FIG. 1 illustrates a block diagram of an example electronic device 100 of the present disclosure. The electronic device 100 can include a storage unit 1, at least one processor 2, and a display 3. The display 3 displays a desktop showing a number of icons respectively associated with a number of applications. When an icon displayed on the desktop is selected, the application associated with the selected icon is activated by the electronic device 100. The electronic device 100 can be a mobile phone, a tablet computer, a PDA, or the like. In alternative embodiments, the electronic device 100 can include more or fewer components than illustrated, or have a different configuration of the various components.

The at least one processor 2 is used to execute applications, such as a desktop icon adjusting system 10, installed to the electronic device 100. The storage unit 1 can store one or more programs, such as the desktop icon adjusting system 10 and other applications of the electronic device 100. The storage unit 1 can be a storage card, such as a memory stick, a smart media card, a compact flash card, a secure digital card, or any other type of memory storage device. The display 3 displays visible data, such as videos, and images, for example.

In at least one embodiment, the desktop icon adjusting system 10 can include a recording module 11, an obtaining module 12, a classification module 13, an arrangement module 14, and a display control module 15.

The recording module 11 can be configured for recording every predefined time interval, a running time period of each of the number of applications installed to the electronic device 100, and each of the number of applications associated with an icon. The recording module 11 can also store the recorded running time period of all applications in the storage unit 1. In at least one embodiment, the recording module 11 records the running time periods of each of the number of applications every predetermined time interval, and records the running time periods of each of the number of applications running during every predetermined interval.

In an alternative embodiment, the recording module 11 can be configured for recording, every predefined time interval, running time period of each of a number of applications associated with icons displayed on the desktop of the electronic device 100.

The obtaining module 12 can be configured for obtaining a number of use times of each application that is associated with the icons displayed on the desktop, during the predefined time interval. The obtaining module 11 can also store the obtained number of use times of each application in the storage unit 1.

The arrangement module 14 can be configured for arranging the icons displayed on the display 3 and associate the number of applications, according to the obtained number of use times and the recorded running time periods of the applications, during every predefined time interval. In at least one embodiment, the arrangement module 14 obtains the number of use times and the recorded running time periods of the applications from the storage unit 1 every predefined time interval (one week, for example).

In at least one embodiment, the arrangement module 14 first ranks the icons associated the applications based on the obtained number of use times of the applications associated with the icons; and then ranks the ranked icons having a same number of use times based on the recorded running time periods of the applications associated with the ranked icons, if some of the ranked icons have a same number of use times. The icon associated with application which has a larger number of use times among a number of applications during the predefined time interval, is arranged in the first place. If more than one application has a same number of use times during the predefined time interval, then the application having a longer running time period, is arranged in the first place. The following table shows exemplary information stored in the storage unit 1.

| | Number of | Running Time |
|---|---|---|
| Applications | Use Times (C) | Periods (min) |
| Pictures | 20 | 600 |
| WeChat | 50 | 700 |
| YuKu Media Player | 80 | 420 |
| FengHuang Net | 40 | 360 |
| TuDou Media Player | 80 | 300 |
| Contacts | 60 | 180 |
| . . . | . . . | . . . |

When the arrangement module 14 makes arrangements regarding the icons associated with the applications listed in the above table, the arrangement module 14 first ranks the icons associated the applications based on the number of use times. The icons associated with the listed applications are temporarily ranked in following sequence: the icon associated with the YuKu Media Player and the icon associated with the TuDou Media Player are first, the icon associated with the Contacts is second, the icon associated with the WeChat is third, the icon associated with the FengHuang Net is fourth, and the icon associated with the Pictures is fifth, etc. Due to the 80 use times of the YuKu Media Player being the same as the 80 use times of the TuDou Media Player during the predefined time interval, the arrangement module 14 continues to rank the ranked icons associated with the YuKu Media Player and the TuDou Media Player based on the recorded running time periods. That is, the icon associated with the YuKu Media Player is ranked before the icon associated with the TuDou Media Player, because the Running Time Period of the YuKu Media Player listed in the table is 420 minutes and is longer than the Running Time Period of the TuDou Media Player. Therefore, the final arrangement, that is a priority queue for the icons associated with the applications listed in the above table is: the icon associated with the YuKu Media Player is first, the icon associated with the TuDou Media Player is second, the icon associated with the Contacts is third, the icon associated with the WeChat is fourth, the icon associated with the FengHuang Net is fifth, and the icon associated with the Pictures is sixth, etc.

In an alternative embodiment, the arrangement module 14 can calculate a weight value for ranking the icons according a predefined formula, the obtained use times and the recorded running time periods of the applications, during every predefined time interval. The arrangement module 14 also can rank the icons associated with the applications based on the calculated weight value. The predefined formula can include factors for calculating weight values of each of the number of applications and weight factors associated with the factors respectively. In at least one embodiment, the predefined formula is P=\sqrt{C*P1+PT2}, wherein P represents a weight value of an application, C represents a number of use times of the application during the predefined time interval, P1 represents a weight factor of the number of use times of the application, T represents the running time period of the application during the predefined time interval, and P2 represents a weight factor of the running time period of the application. The weight factors (eg. P1, P2) are predefined by the system of the electronic device 100 or predefined by the user of the electronic device 100.

The display control module 15 can be configured to display a desktop showing the arranged icons associated with the applications on the display 21 in a predefined display manner.

In at least one embodiment, the predefined display manner is: displaying the desktop on the electronic device 100 showing the ranked icons associated with the applications, the icons in the front of the priority queue are displayed at the center of the displayed desktop and are highlighted or are displayed in a color different from other icons. In an alternative embodiment, the predefined display manner is: displaying the desktop on the electronic device 100 showing the ranked icons associated with the applications in spiral, the icon arranged at the top is displayed in the center of the spiral, and the ranked icons are arranged clockwise or counterclockwise to form the spiral.

In at least one embodiment, the classification module 13 can be configured for classifying the icons displayed on the desktop of the electronic device 100 according to a predefined way. The classification module 13 is configured for marking the classified icons, and each classification of icon is marked. For example, the icons associated with applications of media players are marked as a same classification.

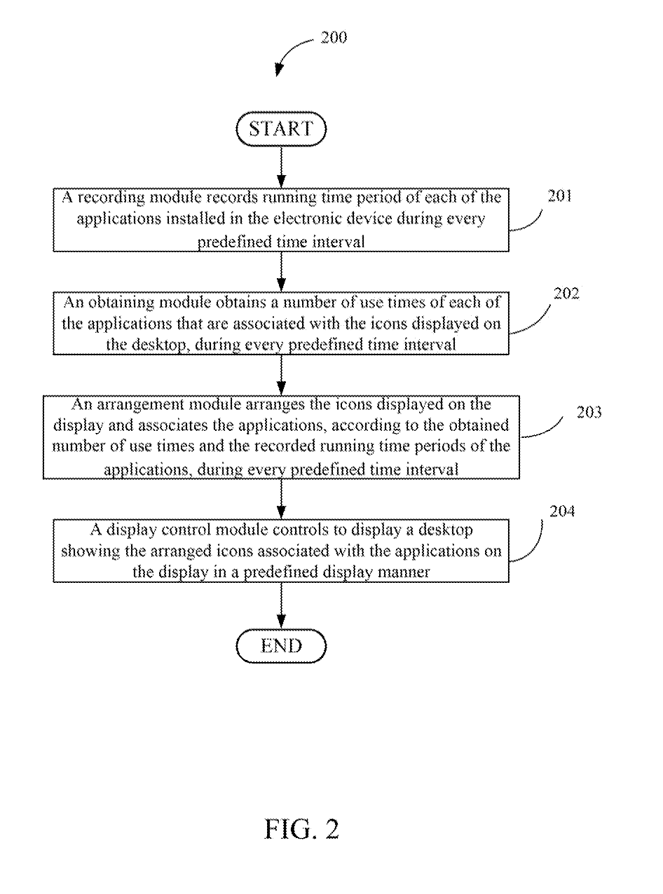

FIG. 2 illustrates a flowchart in accordance with an example embodiment. A method 200 is provided by way of example, as there are a variety of ways to carry out the method. The method 200 described below can be carried out using the configurations illustrated in FIG. 1 and various elements of these figures are referenced in explaining example method 200. Each block shown in FIG. 2 represents one or more processes, methods, or routines, carried out in the exemplary method 200. Furthermore, the illustrated order of blocks is by example only and the order of the blocks can be changed. Additional blocks may be added or fewer blocks may be utilized, without departing from this disclosure. The exemplary method 200 can begin at block 201.

At block 201, a recording module records running time period of each of the applications installed to the electronic device 100 during every predefined time interval. In an alternative embodiment, the recording module records running time period of each of a number of applications associated with icons displayed on the desktop of the electronic device 100.

In another embodiment, the method 200 also can begin at a block before block 201 which is: a classification module classifying the icons displayed on the desktop of the electronic device 100 according to a predefined way.

At block 202, an obtaining module obtains a number of use times of each of the applications that are associated with the icons displayed on the desktop, during every predefined time interval.

At block 203, an arrangement module arranges the icons displayed on the display and associates the applications, according to the obtained number of use times and the recorded running time periods of the applications, during every predefined time interval.

In at least one embodiment, the arrangement module first ranks the icons associated the applications based on the obtained number of use times of the applications associated with the icons; and then ranks the ranked icons having a same number of use times based on the recorded running time periods of the applications associated with the ranked icons, if some of the ranked icons have a same number of use times. The icon associated with application which has a larger number of use times among a number of applications during the predefined time interval, is arranged in the first place. If more than one application has a same number of use times during the predefined time interval, then the application which has the longer running time period, is arranged in the first place.

In an alternative embodiment, the arrangement module calculates a weight value for ranking the icons according a predefined formula, the obtained number of use times and the recorded running time periods of the applications, during every predefined time interval. The arrangement module also ranks the icons associated with the applications based on the calculated weight value. In at least one embodiment, the predefined formula is P=\sqrt{C*P1+TP2}.

At block 204, a display control module controls to display a desktop showing the arranged icons associated with the applications on the display in a predefined display manner.

In at least one embodiment, the predefined display manner is: displaying the desktop on the electronic device 100 showing the icon ranks associated with the applications, the icons in the front of the priority queue are displayed at the center of the displayed desktop and highlighted or displayed in a color different from other icons. In an alternative embodiment, the predefined display manner is: displaying the desktop on the electronic device 100 showing the ranked icons associated with the applications in spiral, the icon arranged at the top is displayed in the center of the spiral, and the icon ranks are arranged clockwise or counterclockwise to form the spiral.

The embodiments shown and described above are only examples. Many details are often found in the art such as the other features of an electronic device and a method thereof for adjusting desktop icons displayed thereon. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A method for adjusting desktop icons displayed on a display of an electronic device, the method comprising:
recording, by a processor during every predefined time interval, a running time period of each of a plurality of applications installed on the electronic device, each of the plurality of applications being associated with an icon;
obtaining, by the processor, a quantity of use times of each of the plurality of applications;
arranging, by the processor during every predefined time interval, the icons associated the plurality of applications according to the quantity of use times and the running time periods of the plurality of applications; and
controlling, by a processor during every predefined time interval, to display a desktop showing the arranged icons on the display in a predefined display manner.

2. The method as claimed in claim 1, wherein the arranging step comprises:
first ranking the icons associated the plurality of applications based on the obtained quantities of use times of the plurality of applications associated with the icons; and
then ranking the ranked icons having a same quantity of use times based on the recorded running time periods of the plurality of applications associated with the ranked icons.

3. The method as claimed in claim 1, wherein the arranging step comprises:
calculating a weight value for ranking the icons according a predefined formula, the obtained quantity of use times and the recorded running time periods of the applications, during every the predefined time interval, wherein the predefined formula comprises factors for calculating weight values each of the plurality of applications and weight factors associated with the factors respectively; and
ranking the icons associated with the applications based on the calculated weight value.

4. The method as claimed in claim 3, wherein the predefined formula is P=\sqrt{C*P1+TP2}, P represents a weight value of an application, C represents a quantity of use times of the application during the predefined time interval, P1 represents a weight factor of the quantity of use times of the application, T represents the running time period of the application during the predefined time interval, and P2 represents a weight factor of the running time period of the application.

5. The method as claimed in claim 1, wherein the predefined display manner is: displaying the desktop on the electronic device showing the ranked icons associated with the applications, the icons in the front of the priority queue being displayed at the center of the displayed desktop and being highlighted or being displayed in a color different from other icons.

6. The method as claimed in claim 1, wherein the predefined display manner is: displaying the desktop on the electronic device 100 showing the ranked icons associated with the applications in spiral, the icon arranged at the top being displayed in the center of the spiral, and the ranked icons being arranged clockwise or counterclockwise to form the spiral.

7. An electronic device, comprising:
a display, configured for displaying a desktop showing a plurality of icons associated with a plurality of applications respectively;
a storage unit;
a processor configured to execute instructions stored in the storage unit for:
recording, during every predefined time interval, a running time period of each of a plurality of applications installed on the electronic device, each of the plurality of applications being associated with an icon;
obtaining a quantity of use times of each of the plurality of applications;
arranging, during every predefined time interval, the icons associated the plurality of applications according to the quantity of use times and the running time periods of the plurality of applications; and
controlling to display a desktop showing the arranged icons on the display in a predefined display manner.

8. The electronic device as claimed in claim 7, wherein the arranging step comprises:
firstly ranking the icons associated the plurality of applications based on the obtained quantities of use times of the plurality of applications associated with the icons; and
then ranking the ranked icons having a same quantity of use times based on the recorded running time periods of the plurality of applications associated with the ranked icons.

9. The electronic device as claimed in claim 7, wherein the arranging step comprises:
calculating a weight value for ranking the icons according a predefined formula, the obtained quantity of use times and the recorded running time periods of the applications, during every the predefined time interval, wherein the predefined formula comprises factors for calculating weight values each of the plurality of applications and weight factors associated with the factors respectively; and
ranking the icons associated with the applications based on the calculated weight value.

10. The electronic device as claimed in claim 9, wherein the predefined formula is P=\sqrt{C*P1+TP2}, P represents a weight value of an application, C represents a quantity of use times of the application during the predefined time interval, P1 represents a weight factor of the quantity of use times of the application, T represents the running time period of the application during the predefined time interval, and P2 represents a weight factor of the running time period of the application.

11. The electronic device as claimed in claim 7, wherein the predefined display manner is: displaying the desktop on the electronic device showing the ranked icons associated with the applications, the icons in the front of the priority queue being displayed at the center of the displayed desktop and being highlighted or being displayed in a color different from other icons.

12. The electronic device as claimed in claim 7, wherein the predefined display manner is: displaying the desktop on the electronic device 100 showing the ranked icons associated with the applications in spiral, the icon arranged at the top being displayed in the center of the spiral, and the ranked icons being arranged clockwise or counterclockwise to form the spiral.
